(19) United States
(12) Patent Application Publication
(10) Pub. No.: US 2013/0098543 A1
(43) Pub. Date: Apr. 25, 2013

(54) METHOD OF APPLYING WINDOW FILM

(71) Applicants: Robert J. Reuter, Woodbury, MN (US); Audrey A. Sherman, St. Paul, MN (US)

(72) Inventors: Robert J. Reuter, Woodbury, MN (US); Audrey A. Sherman, St. Paul, MN (US)

(73) Assignee: 3M INNOVATIVE PROPERTIES COMPANY, ST. PAUL, MN (US)

(21) Appl. No.: 13/807,542

(22) PCT Filed: Jun. 13, 2011
(86) PCT No.: PCT/US2011/040154

§ 371 Date: Dec. 28, 2012

Related U.S. Application Data
(60) Provisional application No. 61/359,630, filed on Jun. 29, 2010.

(51) Int. Cl. B32B 38/10

(52) U.S. Cl. CPC B32B 38/10
USPC 156/247

(57) ABSTRACT

Disclosed herein is a method of applying window film to a window without water. The method includes providing a laminate having an adhesive layer disposed between a window film and a release liner. A portion of the adhesive layer is exposed and contacted with a window pane, and this sequence of steps is repeated until the adhesive layer is completely exposed. The window film is smoothed to the edges of the window pane and trimmed such that a gap between the edges of the window film and the frame is from about 1/32 to about 1/4 inches. Trapped air from between the window film and the window pane by pushing the trapped air out from between the adhesive layer and the window pane using the flat edge of a tool. The adhesive layer may be self-wetting and/or removably repositionable. The window film may be a solar film, an anti-shattering film, a privacy film, a decorative film, a graphic, a radio frequency blocking film, or a combination thereof.

### FIELD

This disclosure to a method of applying window film to a window comprising a window pane enclosed by a frame.

### BACKGROUND

Window films are generally polymeric films having some amount of transmission to radiation such as visible light. Window films are often applied to a window pane using water to attach and position the film on the pane. Water and any air trapped between the film and the pane is expelled by smoothing a tool with slight pressure across the surface of the film. The film is trimmed such that the edges are close to and even with a frame that encloses the window. Application can be messy and frustrating because water can damage the frame or other nearby objects, and the window film can be difficult to cut accurately and evenly at the edges against the frame. Application can also be costly because a significant amount of window film is often thrown away if the film is accidentally creased or if edges are not cut correctly. Trapped air causes visual distortions and can be difficult to remove without destroying the film. Professional installers are often used to install window films which also adds additional cost.

### SUMMARY

Disclosed herein is a method of applying window film to a window comprising a window pane enclosed by a frame, comprising: providing a laminate comprising an adhesive layer disposed between a window film and a release liner, wherein the laminate is oversized relative to the window pane, separating the release liner and the adhesive layer to expose a portion of the adhesive layer, contacting the exposed portion of the adhesive layer to the top of the window pane such that the window film completely covers the window pane, removing the release liner to expose a remaining portion of the adhesive layer, contacting the remaining portion of the adhesive layer to the window pane, smoothing the window film to edges of the window pane such that the window film is flush with the window pane and frame, trimming the window film with a tool such that the gap between the edges of the window film and the frame is from about 1/32 to about ¼ inch, and removing trapped air from between the window film and the window pane by pushing the trapped air out from between the adhesive layer and the window pane using the flat edge of a tool, wherein the method is carried out without water.

In some embodiments, the adhesive layer is urea- or urethane-based. The adhesive layer may be self-wetting and/or removably repositionable.

In some embodiments, the window film comprises a solar film, an anti-shattering film, a privacy film (translucent but not opaque), a decorative film, a graphic, a radio frequency blocking film (prevent use of cell phones), or a combination thereof.

These and other aspects of the invention are described in the detailed description below. In no event should the above summary be construed as a limitation on the claimed subject matter which is defined solely by the claims as set forth herein.

### BRIEF DESCRIPTION OF DRAWINGS

Advantages and features of the invention may be more completely understood by consideration of the following figures in connection with the detailed description provided below. The figures are schematic drawings and illustrations and are not necessarily drawn to scale.

FIG. 1 shows a schematic cross section of an exemplary laminate comprising window film.

FIGS. 2a-2h show illustrations of the method for applying window film to a window pane of a window frame assembly.

### DETAILED DESCRIPTION

The present application is related to co-pending and commonly assigned PCT Application No. ______ (Attorney Docket No. 66365W0003), entitled “Method of Applying Window Film”.

Most methods of applying window films utilize water to attach the film to a window pane. Methods which utilize water can be messy and cause damage to the window frame assembly or surrounding objects. The method disclosed herein is advantageous because it can be used to apply window films without water. The method disclosed herein utilizes “dry-apply” adhesive in the form of an adhesive layer on the window film. The dry-apply adhesive layer can be self-wetting and allow the window film to be removable such that it can be repositioned until desired positioning of the film is obtained on the window pane.

The method disclosed herein can also facilitate handling of large sheets of window films to large window panes, with little exposure and contamination of the adhesive layer at any time during application.

Further, the method disclosed herein can minimize problems associated with air trapped between the adhesive layer and the window pane. When a conventional window film and method are used, the film is smoothed down with slight pressure on the pane in order to expel trapped air. However, air is typically trapped in the form of bubbles, and small air bubbles can be very difficult to remove without damaging the film. The method disclosed herein can facilitate application of the window film because small air bubbles can dissipate on their own. The result is an aesthetic, visually appealing, window.

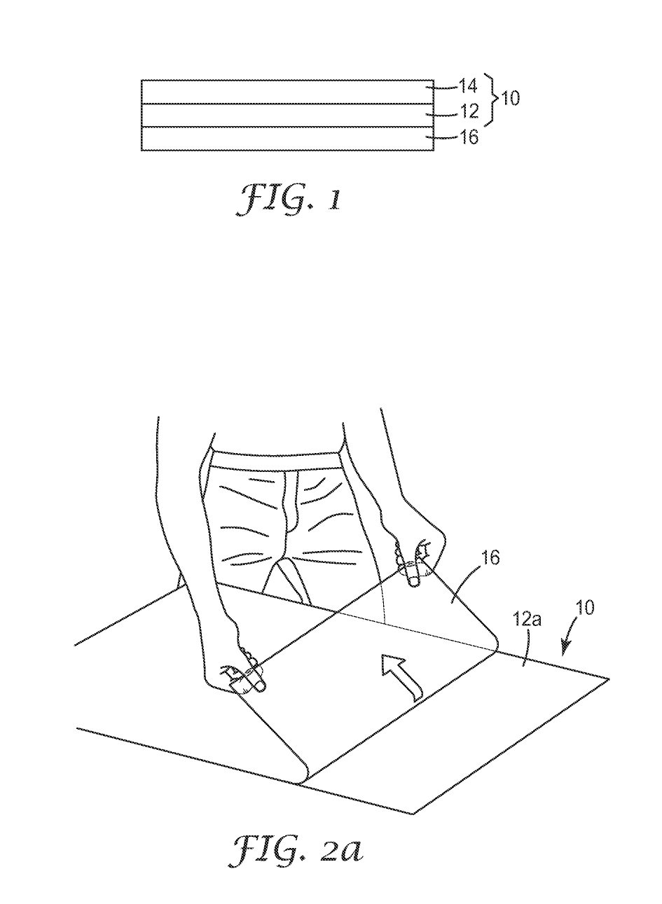

FIG. 1 shows a schematic cross section of window film 10 comprising adhesive layer 12 disposed on window film layer 14. Release liner 16 is disposed on adhesive layer 12. Window film 10 and release liner 16 form a laminate which is generally flat and flexible and is supplied in the form of sheets or rolls.

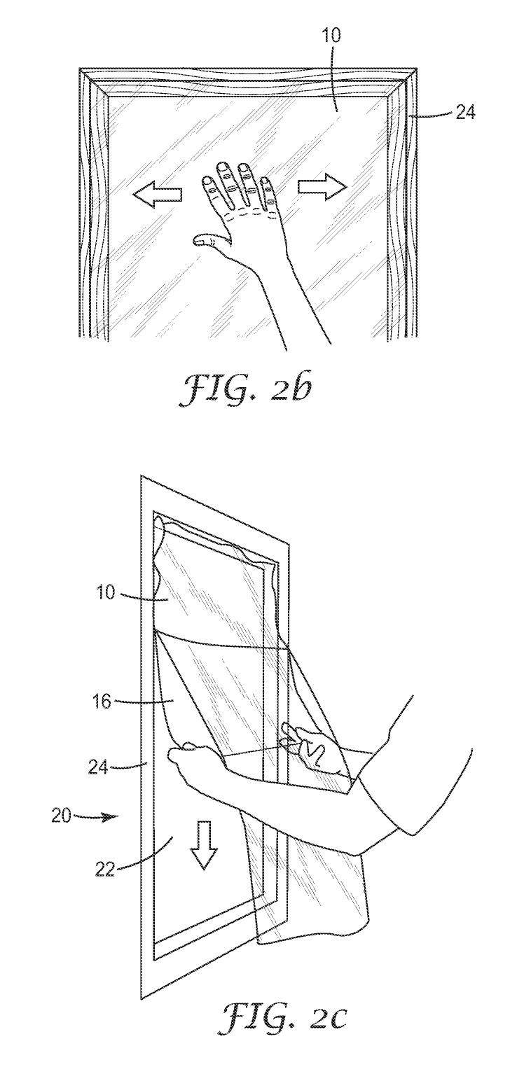

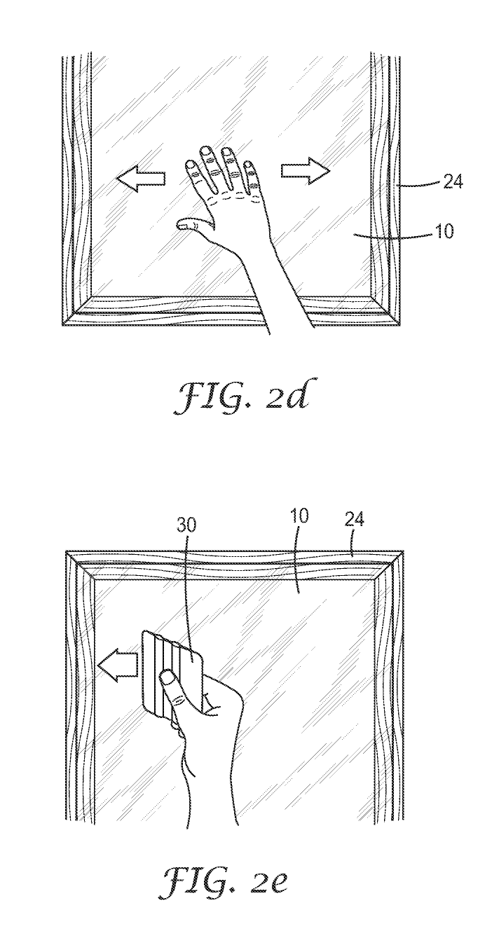

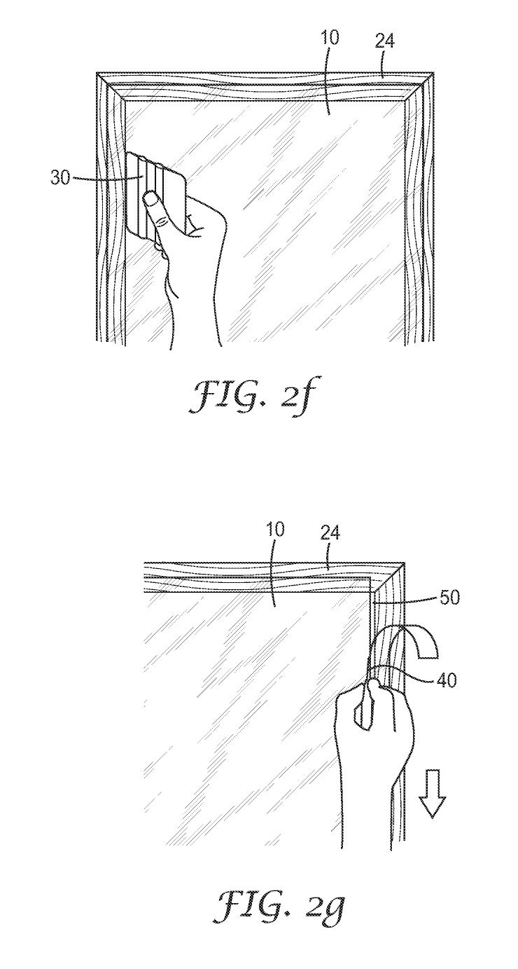

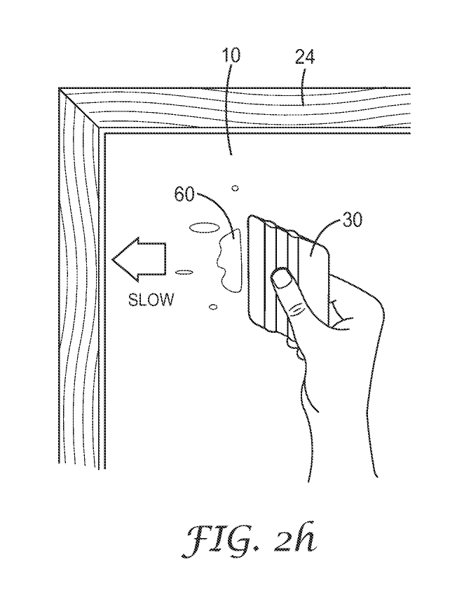

FIG. 2a illustrates a first step of the method in which the laminate is laid on a flat surface, and release liner 16 and adhesive layer 12 are separated to expose portion 12a of the adhesive layer. A user can carry out the separation by pulling release liner 16 up and toward himself as shown by the arrow. Before this step is carried out, the laminate is pre-cut to have an area larger than that of the window pane. For example, the pre-cut window film can have an area such that it extends at least 2 inches beyond each edge of the window pane to be covered. Generally, the term “window pane” refers to that part of the window pane which is visible, i.e., window pane does not include that part of the window pane which is underneath or inserted into a window frame.

FIG. 2b illustrates a next step in which portion 12a of the adhesive layer is contacted with the upper portion of a window pane such that window film 10 covers the pane and overlaps onto frame 24. Window film 10 is supported by the adhesive layer adhered to the window pane. Preferably, the film is positioned such that it overlaps frame 24 by about ½ inch after it is smoothed down upon the pane as shown by the arrows.

FIG. 2c illustrates window assembly 20 comprising window pane 22 enclosed by frame 24. In this next step, the user reaches under window film 10 and holds both sides of release liner 16. The release liner is slowly pulled down to expose more of adhesive layer 12. The extent to which the adhesive is exposed in this step can depend on the size of the window film. For example, if the window pane to be covered is very large, the user may expose an additional portion of the adhesive layer, for example, an additional 6 inches in length. If the window pane to be covered is not very large, the user may expose the remaining portion of the adhesive layer. The extent to which the adhesive layer is exposed in this step can also depend on the experience of the user.

FIG. 2d illustrates contact of the lower portion of window film 10 (with the newly exposed adhesive layer) with the lower portion of the window pane enclosed by frame 24. The user gently presses the adhesive layer to the window pane, pushing down at the center and sliding his hand towards the left and right sides of the window pane against frame 24 as shown by the arrows. Any lumps or ridges in the window film can be removed by lifting a corner of the window film and slowly lowering the film back onto the window pane. If the release liner is not completely separated from the adhesive layer, then the user repeats the step described above for FIG. 2c. Window film 10 lies flat or nearly flat against the window pane after the step described for FIG. 2d is completed. At this point in the method, the user need not worry about any bubbles caused by trapped air between the window film and the window pane because of the advantages of the adhesive layer as described below.

FIGS. 2e and 2f illustrate the next step in which a smoothing tool, such as smoothing tool 30, is used to smooth down the window film onto the window pane from the center to the edges where the window pane meets frame 24. Suitable smoothing tools provide a flat edge that will not damage the window film during the smoothing step. Window film 10 should adhere up to the edges and up against the frame. Preferably, the user does not remove or attempt to remove air bubbles during this step.

FIG. 2g illustrates the next step in which window film 10 is trimmed with cutting tool 40. Ideally, gap 50 between the cut edge of window film 10 and frame 24 is less than about ¼ inch, and the gap is about the same on all sides of the cut film. Suitable cutting tools include utility knives or cutting tools especially made for trimming window film as described, for example, in U.S. Ser. No. 61/359634.

FIG. 2h shows the next step in which air bubbles 60 are removed from between window film 10 and window pane 22 using smoothing tool 30. Air bubbles 60 are pushed out toward the edges of the cut window film by slowly pushing the bubbles out as shown by the arrow. Preferably, only large air bubbles of greater than about ⅛ inch in any direction are removed using the smoothing tool. Any bubbles less than ⅛ inch disappear gradually over the next few days.

The adhesive layer may be self-wetting, i.e., the adhesive layer may spontaneously wet the window pane by pulling itself down using its own weight, with little or no added pressure on the window film. The adhesive layer may be removable, i.e., the adhesive layer may have removable properties such that it can be bonded and removed from a window pane repeatedly for repositioning or reworking. The adhesive layer may exhibit initial removability by having a 90° peel force of less than about 75 g/in, and after one week at room temperature, a 90° peel force of less than about 400 g/in, less than about 200 g/in, or less than about 100 g/in. (Peel force may be measured using a peel tester from IMASS.) The adhesive layer may have strong cohesive strength for structural integrity, limiting cold flow and giving elevated temperature resistance, in addition to permanent removability.

The adhesive layer may comprise the cured reaction product of a multifunctional ethylenically unsaturated siloxane polymer and one or more vinyl monomers as described in US 2007/0055019 A1 (Sherman et al.; Attorney Docket No. 60940US002) and US 2007/0054133 A1 (Sherman et al.; Attorney Docket No. 61166US002).

The adhesive layer may be a pressure sensitive adhesive layer, exhibiting aggressive tack with little added pressure when applied. An exemplary pressure sensitive adhesive comprises a polymer derived from an oligomer and/or monomer comprising polyether segments, wherein from 35 to 85% by weight of the polymer comprises the segments. These adhesives are described in US 2007/0082969 A1 (Malik et al.).

In some cases, the adhesive layer comprises an adhesive that does not contain silicone. Silicones comprise compounds having Si—O and/or Si—C bonds. An exemplary adhesive comprises a non-silicone urea-based adhesive prepared from curable non-silicone urea-based oligomers as described in WO 2009/085662 (Sherman et al.; Attorney Docket No. 63704W0003). A suitable non-silicone urea-based adhesive may comprise an X—B—X reactive oligomer and ethylenically unsaturated monomers. The X—B—X reactive oligomer comprises X as an ethylenically unsaturated group, and B as a non-silicone segmented urea-based unit having at least one urea group.

Another exemplary adhesive comprises a non-silicone urethane-based adhesive as described in WO 2010/132176 (Sherman et al.; Attorney Docket No. 65412W0003). A suitable urethane-based adhesive may comprise an X—A—B—A—X reactive oligomer and ethylenically unsaturated monomers. The X—A—B—A—X reactive oligomer comprises X as an ethylenically unsaturated group, B as a non-silicone unit with a number average molecular weight of 5,000 grams/mole or greater, and A as a urethane linking group.

Many different types of window films, either the window film layer alone or in combination with the adhesive layer, are available for delivering a wide range of optical and/or mechanical properties. The window film may comprise a solar film that minimizes the amount of heat entering a building through sunlight, thereby decreasing the amount of energy needed to cool the building. The window film may comprise a solar film that reflects a desired amount of ultraviolet and/or infrared radiation while allowing passage of visible light thereby decreasing the amount of energy needed to cool the building as well as minimizing harm to fabrics, furniture, etc. The window film may comprise an anti-shattering film, or security film, used to prevent glass from shattering. The window film may comprise a privacy film that transmits visible light but which obscures view. The window film may comprise a radio frequency blocking film for preventing or minimizing usage of cell phones, etc. The window film may comprise a decorative film such as a simulated prism film or a frosted film. The window film may be colored and/or provide an image such as a graphic.

The window film may be optically clear, having: high light transmittance of from about 80 to about 100%, from about 90 to about 100%, or from about 95 to about 100% over at least a portion of the visible light spectrum (about 400 to about 700 nm); and a haze value of less than about 5%, or less than about 1%. Haze values in transmission can be determined using a haze meter according to ASTM D1003. The window film may be translucent in that it reflects and transmits light.

The window film layer typically comprises a polymeric film having one or more polymeric layers. Exemplary polymeric films include polyester films, polyacrylate films, cellulose-based films, etc. The polymeric film may comprise a multilayer optical film having from about 10 to about 10,000 alternating layers of first and second polymer layers wherein the polymer layers comprise polyesters. Exemplary multilayer optical films are described in WO 2010/005655 (Sherman et al.; Attorney Docket No. 60430US006) and references cited therein. The multilayer optical film may comprise a specular reflector available from 3M™ Company, for example, 3M™ High Intensity Grade Reflective Products such as High Reflective Visible Mirror Film and High Transmission Mirror Film, and Vikuiti™ films such as Vikuiti™ Enhanced Specular Reflector.

The release liner may have a low adhesion surface for contact with the adhesive layer. Release liners may comprise paper such as Kraft paper, or polymeric films such as poly(vinyl chloride), polyester, polyolefin, cellulose acetate, ethylene vinyl acetate, polyurethane, and the like. The release liner may be coated with a layer of a release agent such as a silicone-containing material or a fluorocarbon-containing material. The release liner may comprise paper or a polymeric film coated with polyethylene which is coated with a silicone-containing material. Exemplary release liners include liners commercially available from CP Films Inc. under the trade designations “T-30” and “T-10” that have a silicone release coating on polyethylene terephthalate film.

Exemplary release liners include structured release liners. Exemplary release liners include any of those referred to as microstructured release liners. Microstructured release liners are used to impart a microstructure on the surface of an adhesive layer. The microstructured surface can aid air egress between the adhesive layer and the adjacent layer. In general, it is desirable that the microstructure disappear over time to prevent interference with optical properties. Microstructures are generally three-dimensional structures that are microscopic in at least two dimensions (i.e., the topical and/or cross-sectional view is microscopic). The term “microscopic” as used herein refers to dimensions that are difficult to resolve by the human eye without aid of a microscope.

What is claimed is:

1. A method of applying window film to a window comprising a window pane enclosed by a frame, comprising:
providing a laminate comprising an adhesive layer disposed between a window film and a release liner, wherein the laminate is oversized relative to the window pane,
separating the release liner and the adhesive layer to expose a portion of the adhesive layer,
contacting the exposed portion of the adhesive layer to the top of the window pane such that the window film completely covers the window pane,
removing the release liner to expose a remaining portion of the adhesive layer,
contacting the remaining portion of the adhesive layer to the window pane,
smoothing the window film to edges of the window pane such that the window film is flush with the window pane and frame,
trimming the window film with a tool such that the gap between the edges of the window film and the frame is from about 1/32 to about ¼ inch, and
removing trapped air from between the window film and the window pane by pushing the trapped air out from between the adhesive layer and the window pane using the flat edge of a tool,
wherein the method is carried out without water.

2. The method of claim 1, wherein the adhesive layer comprises a cured mixture comprising at least one X—B—X reactive oligomer, wherein X comprises an ethylenically unsaturated group, and B comprises a non-silicone segmented urea-based unit.

3. The method of claim 1, wherein the adhesive layer comprises a cured mixture comprising at least one X—A—B—A—X reactive oligomer, wherein X comprises an ethylenically unsaturated group, B comprises a non-silicone unit with a number average molecular weight of 5,000 grams/mole or greater, and A comprises a urethane linking group.

4. The method of claim 1, wherein the adhesive layer does not comprise silicone.

5. The method of claim 1, wherein the adhesive layer is self-wetting.

6. The method of claim 1, wherein the adhesive layer is removably repositionable.

7. The method of claim 1, wherein the film comprises a solar film, an anti-shattering film, a privacy film, a decorative film, a graphic, a radio frequency blocking film, or a combination thereof.
